(19) United States
(12) Patent Application Publication
(10) Pub. No.: US 2014/0190897 A1
(43) Pub. Date: Jul. 10, 2014

(54) ENHANCED SEPARATION OF NUISANCE MATERIALS FROM WASTEWATER

(71) Applicant: George E. Wilson, Ridgefield, WA (US)

(72) Inventor: George E. Wilson, Ridgefield, WA (US)

(21) Appl. No.: 14/206,740

(22) Filed: Mar. 12, 2014

Related U.S. Application Data
(63) Continuation of application No. PCT/US2012/054807, filed on Sep. 12, 2012.
(60) Provisional application No. 61/533,728, filed on Sep. 12, 2011.

(51) Int. Cl. C02F 1/24

(52) U.S. Cl. CPC C02F 1/24
USPC 210/704; 210/703; 210/202

(57) ABSTRACT

According to one implementation, a method of treating wastewater includes introducing air bubbles having a predetermined size into raw influent, allowing the air bubbles time to bind with grease particles in the influent and to rise, and collecting the grease particles bound with the air bubbles on an upper surface of the influent.

### CROSS REFERENCE TO RELATED APPLICATION

The present application is a continuation of co-pending International Patent Application No. PCT/US2012/054807, filed Sep. 12, 2012, which claims the benefit of U.S. Provisional Patent Application No. 61/533,728, filed Sep. 12, 2011, both of which are incorporated herein by reference.

### FIELD

This application relates to wastewater treatment, and in particular, to methods and apparatus for enhanced separation of nuisance materials from wastewater.

### BACKGROUND

Common nuisance materials that wastewater treatment plants must address include gravel, grease, garbage and grit. Gravel is understood to have an inorganic particle diameter of at least 0.125 in and is typically received in wastewater treatment plants only occasionally, such as due to excess flow events. Grease is organic, lower density material that is buoyant in water and hydrophobic. Garbage is understood in this context to be organic material that tends to float in the wastewater, e.g., lettuce leaves and the like, primarily because of its surface area. Grit is understood to include inorganic particles that are settleable (settling velocity greater than 1.3 ft/s).

Preventing nuisance materials such as gravel, grease, garbage and grit from being added to a wastewater influent stream is often addressed by pretreatment systems upstream of the wastewater treatment plant. Conventionally, upstream of many wastewater collection systems, traps are used to capture oils, greases and grit before they enter the collection system. Such traps, however, fail to prevent entry of grease and grit into the collection systems, and they are labor intensive to maintain. Consequently, nuisance materials continue to plague wastewater treatment plants.

Efforts to remove nuisance materials, including grease skimming, grit gravity settling and grit aeration, have failed to achieve sufficient results, and plant operators still seek more effective, economical and safer alternatives.

### SUMMARY

Described below are implementations of methods and apparatus for addressing some of the problems of the prior art approaches.

Nuisance materials can be separated from influent by gravity separation. In the case of grease and garbage, with sufficient time, these materials will rise to the top of a tank of influent, because the water in the influent has a higher specific gravity than that of the grease or the garbage. In the case of grit and gravel, with sufficient settling times, these materials will settle to the bottom of a settling tank or receptacle, although at very different rates. Under many conditions, if a sufficient time period is provided to allow grease and/or garbage to rise, then at least any gravel and usually some of the grit will have settled in that same time period. Thus, providing for removal of gravel and other materials separable after settling concurrent with removal of grease, garbage and other materials separable after rising is advantageous in certain circumstances.

According to one method of treating wastewater, air bubbles are injected into raw influent in a holding chamber, the air bubbles are allowed time to bind with grease particles in the influent and to rise, the grease particles bound with air bubbles and floating garbage are collected on an open upper surface of the influent, and the gravel that has settled is collected from a bottom region of the holding tank. This method of aspirated aeration can further comprise conveying the influent, which has been degreased as well as cleared of gravel and garbage, downstream for subsequent grit removal and other processing.

The bubbles can be generated using an injector (sometimes referred to as an educator, ejector or aspirator) having a motive water jet that passes through a nozzle in the injector body and in turn draws air into the injector. The air and water mixture is subjected to intense shear forces in the injector, which tends to reduce the size of the air bubbles. The injecting can be carried out with an array of spaced apart injectors. The injecting can take place near a bottom of the holding chamber, but above any accumulation of settled material (such as gravel and/or grit).

Further, surfactant can be mixed with the motive water to produce a water-air-surfactant mixture, with the surfactant functioning to keep the bubbles from coalescing into larger bubbles. The surfactant is added to the small volume motive water, thus achieving its effect in very small volumes. This avoids the need to add much larger volumes of the surfactant to the wastewater stream, which would ultimately need to be removed before final disposition of the effluent and thus would ultimately be counterproductive.

In some implementations, the injected water-air-surfactant mixture is of a volume sufficient to reduce the density of the influent in the holding chamber. In such a case, both the resulting rise velocity of the bound grease particles and the settling velocity of gravel and other particles are increased.

Collecting the grease particles bound with the bubbles can include skimming an upper surface of the influent to remove the grease. Garbage can be removed from the surface in the same way. Skimming an upper surface of the influent can include using an air stream to remove the grease. Further, the method can include dewatering the removed grease and recycling liquid removed from the dewatered grease to the raw influent. For example, the method can include urging the removed grease up a ramp positioned adjacent the upper surface of the influent, and concurrently dewatering the removed grease.

A removal stage of a wastewater treatment system according to one implementation comprises a tank configured to receive an inflow of influent, at least one injector, and a skimming device. The injector is positioned near a bottom of the tank to inject a water-air mixture or a water-surfactant-air mixture into influent received in the tank. The skimming device is positioned to skim grease bound with air bubbles from a top surface of the tank.

The at least one injector can comprise a high shear injector. The at least one injector can comprise an array of multiple injectors arranged about a central axis of the tank. The skimming device can comprise a nozzle positioned to direct an air stream onto the top surface of the tank and to move accumulated grease to an opposite side. The removal stage can comprise a dewatering ramp positioned adjacent the top surface of the tank. Accumulated grease can be skimmed across the top surface of the tank and up the dewatering ramp, thereby allowing liquid in the accumulated grease to be dewatered and recycled to the tank.

As a result of injecting the water-air mixture or water-surfactant-air mixture into the influent, its density is reduced. Therefore, gravel in the influent will settle more quickly in the lower density region than in other normal density regions. The foregoing features and advantages will become more apparent from the following detailed description, which proceeds with reference to the accompanying figures.

### BRIEF DESCRIPTION OF THE DRAWINGS

FIG. 1 is a schematic diagram of an implementation of a wastewater system having a new nuisance material removal stage in combination with a downstream grit removal stage and a downstream further processing stage.

FIG. 2 is a flow chart of a new nuisance material removal method according to one implementation.

FIGS. 3 and 4 are sectioned elevation and plan views, respectively, of a nuisance material removal system according to an alternative implementation.

FIGS. 5 and 6 are sectioned elevation and plan views, respectively, of a nuisance material removal system according to another alternative implementation.

FIG. 7 is a schematic perspective view of another implementation of the system of FIG. 1.

FIGS. 8A to 8E are side elevation, front elevation, top plan, sectioned elevation and perspective views, respectively, of an alternative aspirator.

FIGS. 9A and 9B are schematic views showing the sizes of typical air bubbles formed in water and the smaller air bubbles formed by the aspirator of FIGS. 8A-8E.

FIG. 10 is a control volume diagram showing the inputs to and outputs from a typical control volume of effluent being treated.

FIG. 11 is a schematic view of a control volume or tank of effluent in which grease and/or garbage are being removed from the top surface.

FIG. 12 is a flow chart of another nuisance material removal method according to another implementation.

FIG. 13 is a sectioned elevation view of a nuisance material removal system according to another implementation.

### DETAILED DESCRIPTION

Nuisance materials that remain in an influent stream interfere with subsequent treatment processes. Nuisance materials such as gravel, grease, grit and garbage have no significant pollutional strength, and once they have been separated, typically no further treatment is required prior to disposal in a landfill. But conventional approaches at addressing such nuisance materials have failed, especially from the standpoint of providing any solution that addresses two or more of these materials simultaneously. In addition, may conventional attempts have involved devices that are inefficient, raise significant maintenance issues and/or require too much space to allow for effective retrofitting in existing plants.

Gravel typically enters the wastewater influent stream during high flow events, such as in stormwater runoff. If allowed to remain in the influent, gravel causes complications in pumps and screens of the headworks. Garbage is conventionally removed using screens, but these and similar devices are problematic because the abrasive grit, which remains in the influent, quickly wears the screens and other similar mechanical parts. Grease removal has been attempted by skimming accumulated grease from the surface, but the grease that remains and fouls the walls of settling tanks and skimming/scraping devices requires substantial maintenance.

According to the described approaches, separation takes place using methods that rely on hydraulic forces generated by fluid flows responding to gravity or as urged against gravity by a jet or similar device. Blades and other similar moving parts are disfavored because they create locations for the nuisance materials to collect and thus, they invariably lead to maintenance issues. According to described implementations, 90% or more of the grease can be removed from the raw wastewater.

Surprisingly, it has been found that the settling of grit and gravel is improved when carried out concurrent with the separation of grease and garbage by rising. More grit and settleable materials per unit volume of influent at the same flow rate are removed than if no concurrent grease/garbage removal treatment is taking place, because the described approach reduces the density of a region of the influent and thus increases the grit settling velocity.

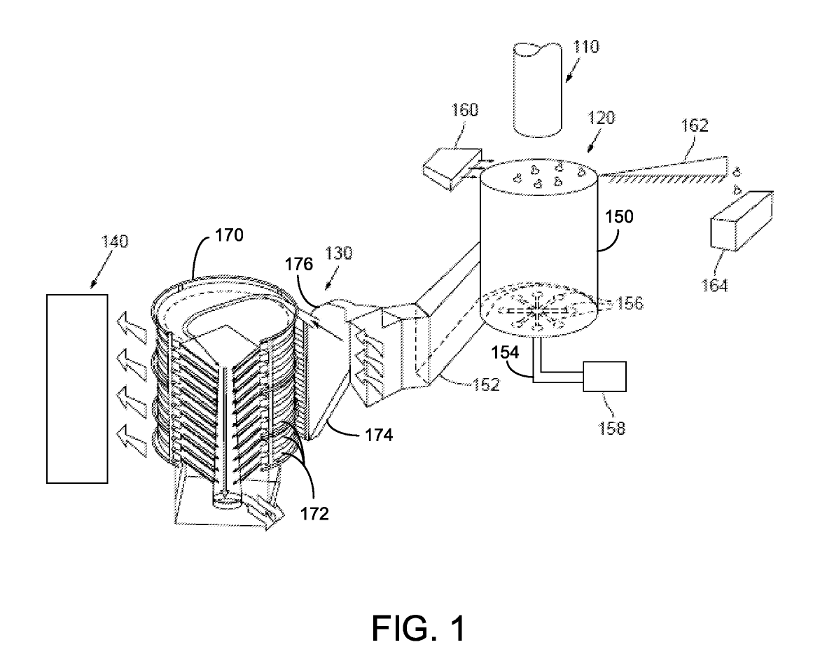

Referring to FIG. 1, a portion of a wastewater treatment system 100 comprises a vertically downward influent stream 110, a grease removal stage 120 fed by the influent stream 110, a grit removal stage 130 downstream of the grease removal stage 120, and an optional additional processing stage(s) 140 downstream of the grit removal stage 130. “Grease” as used herein includes greases, oils and other similar substances.

In FIG. 1, the influent stream 110 is fed from above by gravity into a large, filled settling chamber or tank 150. The tank 150 is configured with an outlet 152 configured for gravity feeding of the downstream grit removal stage 130. The tank 150 has a centrally positioned header 154 with multiple jets 156 that are directed radially outward. In the implementation of FIG. 1, there are eight of such jets 156 equally spaced about a central axis of the tank 150.

The jets 156 act as aspirators, eductors or ejectors by creating sufficient air flow due to their venturi high velocity jets. Desirably, the fluid of the aspirator jets contains a surfactant. The jets draw air into the body of the injector and the water-surfactant-air mixture is then injected in the bottom region of the tank. The injected water-surfactant-air mixture contains very fine air bubbles that rise in the tank, and the rising bubbles bind with grease, thereby causing the grease to rise to the surface of the tank. In some implementations, the jet or jets have a velocity of approximately 50 ft/s.

It has been discovered that using a high shear injector subjects the entrained air to high shear forces, therefore producing air bubbles of a predetermined minimum size. It is estimated that these air bubbles are approximately one quarter of the diameter of a stable air bubble in water.

It has been discovered that having surfactant present with the air and water mixture prevents air bubbles from coalescing and maintains them in their predetermined minimum size. A finer bubble size increases the overall surface area of the bubbles per unit volume and increases the bubbles' ability to attract and bind with the grease suspended in the influent. In one implementation, surfactant from a supply 158 is injected into the tank 150 through the jets 156 together with the air and water mixture.

In another implementation, the concentration of surfactant was 20 L in the injector jet water of 0.6% of the total system flow. A suitable surfactant is conventional liquid hand dishwashing detergent.

Also, higher efficiencies are achieved with a countercurrent downflow of influent liquid that occurs simultaneously with a rising filter cloud of shear-produced minimum size bubbles.

The bound grease and bubbles, which have a frothy, foam-like appearance, accumulate on the surface of the liquid in the tank. The accumulated grease can be collected and removed according to a number of different approaches. For example, the grease can be moved from one side of the top surface of the tank 150 to the opposite side by “skimming” it with an air stream from a nozzle 160. Performing the skimming action with an air stream eliminates the need to have mechanical elements come into contact with the grease. Further, the skimming action can be continued to cause the accumulated grease to be urged up and over a ramp 162, and into a container 164 for disposal. Advantageously, the force of the air stream and the slope of the ramp 162 are set so that the resulting skimming force is just sufficient to urge the accumulated grease up the ramp, but that liquid in the accumulated grease drains away (or is “dewatered”) and flows back into the tank 150. Most of the added surfactant is removed with the grease and garbage, which thereby alleviates the need in most cases to implement a separate removal step for excess surfactant remaining in the influent.

Meanwhile, influent that has been treated to remove grease (“degreased” influent) tends to flow through the outlet 152 into the enhanced grit separation station 130.

According to one implementation, the enhanced grit separation station 130 includes at least one head cell 170. The head cell 170 includes multiple vertically aligned and hydraulically independent trays 172 that are submerged in a chamber (not shown). The degreased influent flows down from the tank 150, through the outlet 152, through a channel 174 joined to the outlet 152 (in FIG. 1, the channel 174 is shown separated from the outlet 152 for clarity), and through separate passageways in a distribution header 176 to enter respective trays 172 tangentially. These tangential flows establish a vortex flow pattern causing solids, including grit particles, to settle into a boundary layer on each tray. Gravity then sweeps the solids to a center opening, allowing them to fall into a common collection sump.

Flow spirals downwardly through the stacked trays and exits the head cell as degreased and “degritted” effluent. Typically, the effluent is subjected to further treatments, such as chemical and biological treatments, in the additional processing stage(s) 140 located downstream.

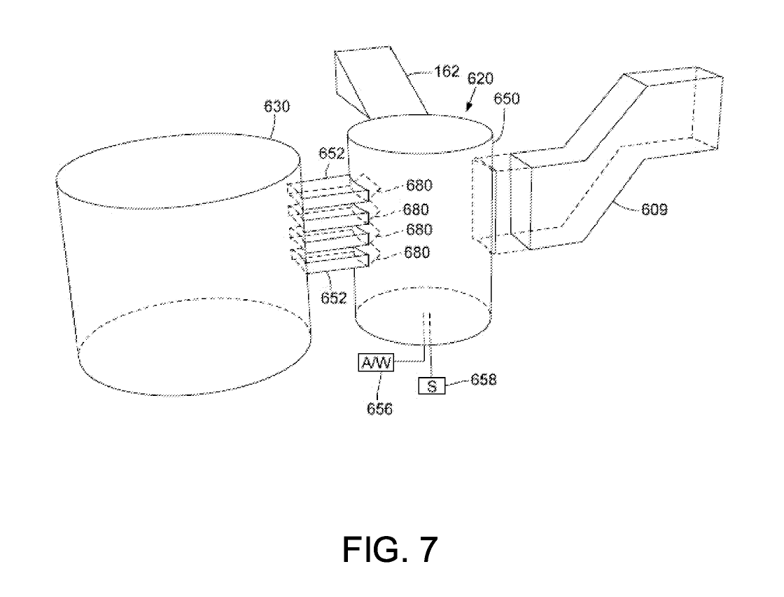

FIG. 7 is schematic perspective view of an alternative implementation of the system of FIG. 1. Generally corresponding components are numbered with the same reference numeral as in FIG. 1, plus 500. As shown, the removal stage 620 includes a settling tank 650 that is fed by an influent stream fed by a duct 609 (shown separated from the tank 650 for clarity). The duct 609 and a corresponding opening in the tank 650 have a generally rectangular cross-section that is relatively tall and narrow.

Flow enters the tank from one side, and flow exits from the generally opposite side. In FIG. 7, flow exits through four outlets 652. The outlets are vertically aligned with and spaced apart from each other. The outlets 652 are positioned for alignment with head cell trays in the grit removal stage 630. Although not specifically shown, the four-outlet configuration of FIG. 7 is designed to feed a head cell with four head cell trays. In general, the size and number of outlets 652 can be selected to yield appropriate head cell entry flow conditions, as well as to allow for sufficient settling time in the grease removal stage 620.

As jets 656, 658 act operate to inject air and surfactant into the influent as described above, the resulting air bubbles are controlled to have a predetermined size and settling rate. The air bubbles entrain grease particles and cause them to ride to the surface. Garbage tends to float to the surface.

As shown in FIG. 7, there is a baffle 680 located in the tank 650 at the opening for each of the outlets 652. The baffles 680 angle upwardly from the lower edge of each opening and project inwardly toward the interior the tank. The baffles 680 prevents the rising air bubbles and grease particles from being diverted through the outlets 652 instead of rising to the surface.

At the same time as the rising action of the grease particles and garbage is occurring, any gravel in the influent is tending to settle at the bottom of the tank 650. Grease and garbage that have reached the surface can be moved up the ramp 162 for convenient disposal.

By emphasizing a vertical orientation, the removal stage 620 is more efficient per unit of footprint, which is particularly beneficial in the case of retrofit installations.

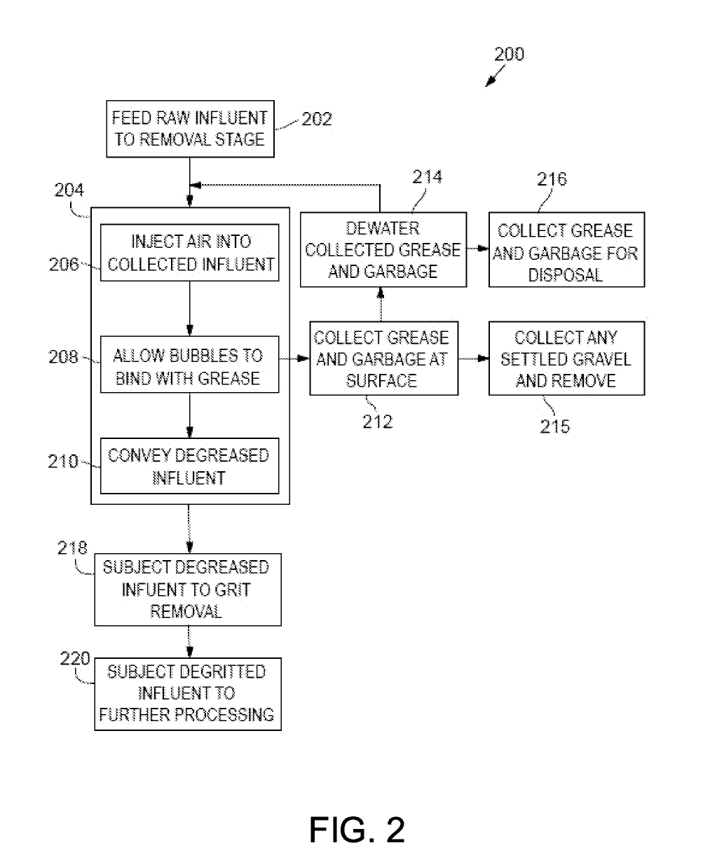

In FIG. 2, a flow chart of a method 200 according to one implementation is shown. In step 202, raw influent is fed into a removal stage.

In step 204, the raw influent is treated to remove grease, and influent in the grease being removed is recycled. At the same time, garbage is removed, and any gravel that has settled is collected.

In a specific implementation, raw influent is collected, such as in a tank, and air or a surfactant-air mixture is injected to create bubbles (step 206). The bubbles tend to bind with the grease in the raw influent as they float to its upper surface (step 208). At the same time, gravel (and some grit) tends to settle, and garbage tends to float to the surface. The “degreased” influent, which has subjected to a grease removal process (as well as processes for removing gravel and garbage), is conveyed to an enhanced grit removal stage for additional processing (step 210).

Meanwhile, grease is collected at the surface (step 212). In a specific implementation, grease is removed from the surface by skimming, such as by using an air stream to move the collected grease (and any garbage that is present) across the surface. It may be advantageous to dewater the collected grease (step 214) and to then recycle the influent into the grease removal stage. In step 215, any gravel that has settled is collected for removal.

The grease that has been removed from the surface, as well as any garbage that has surfaced, can be collected (step 216), such as in a container, for subsequent disposal or recycling.

In step 218, degreased influent is subjected to an enhanced grit removal stage, which may need to be operated only at a lower capacity because of the grit already removed by settling while the grease was rising. In step 220, the degreased and degritted influent is subjected to further processing, such as chemical and biological processing stages.

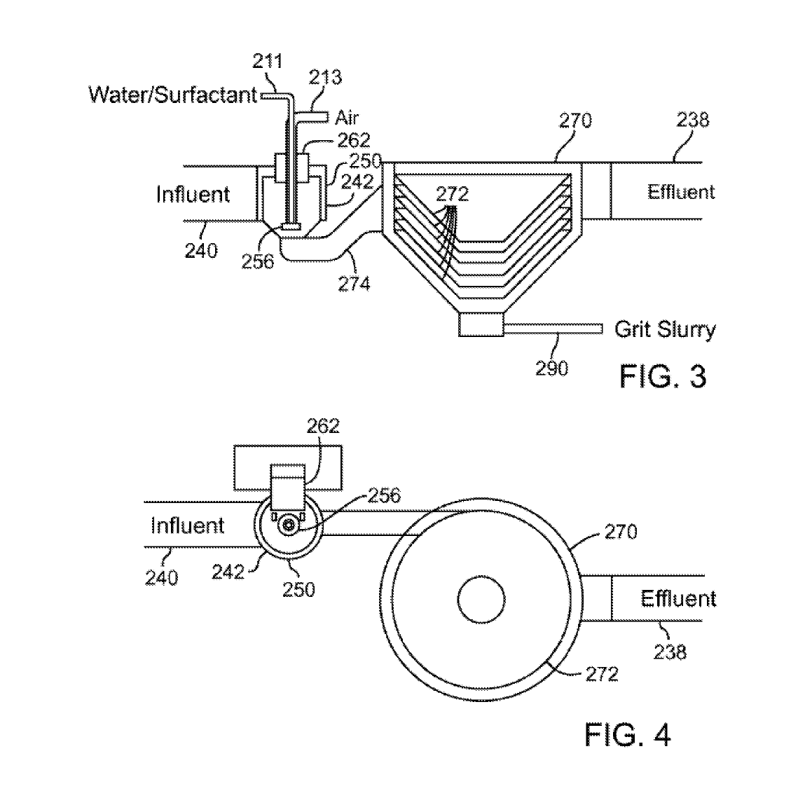

An implementation of a grease and grit removal system according to an alternative approach is shown in FIGS. 3 and 4. In FIGS. 3 and 4, the influent stream 240 is fed, generally by gravity, to a grease removal cell 242. The influent stream 240 enters the tank 250. As shown in FIG. 3, water and surfactant from a first source 211 are used as a motive jet to draw in air from a source 213. The resulting water-surfactant-air mixture is injected into a bottom region of the tank 250. As described above, fine bubbles of a predetermined size are produced and maintained, and these bubbles bind with grease in the influent and thereby lower its density, causing it to rise to the surface of the tank. The accumulated grease is skimmed to one side of the tank 250 as described above and urged up a dewatering ramp 262.

Degreased influent flows through a channel 274 to a head cell 270, as described above in connection with FIG. 1. After the flow of influent spirals through the trays 272, the degreased and degritted effluent 238 exits the head cell.

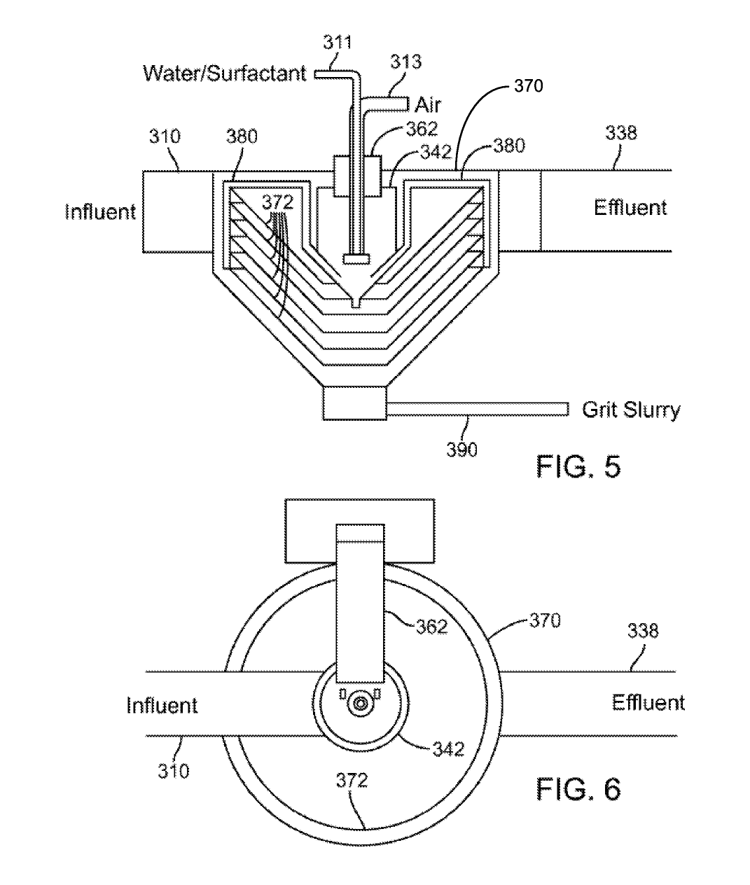

FIGS. 5 and 6 show an alternative implementation in which the grease separating and grit separating portions of the system share the same settling tank 370. In this way, the influent 310 is first fed to the inner grease separating cell 342, and grease is removed from the influent as described above by injecting water-surfactant-air mixture near the bottom of the cell to bind with grease particles and cause them to rise to rise to the top surface where they can be separated from the rest of the influent. The degreased influent, which includes the influent recovered from the dewatering of the grease on the ramp 362 and the influent that overflows the grease separating cell 342, exits the grease separating cell 342 at one or more points on an upper periphery thereof and is conveyed through a duct 380 into the multiple trays 372. The degreased influent is then subjected to vortical separation of grit as it spirals through the vertically aligned trays 372. Grit settles out from the influent to the bottom and is evacuated as a grit slurry at 390. The degreased and degritted effluent 338 is ducted away from the head cell and can be subjected to further processing downstream.

The source of air for the aspirators may be atmospheric air or compressed air. In many installations, compressed air is readily available. In addition, compressed air can be used to supply the air stream for skimming the grease, e.g., through the nozzle 160.

### Alternative Aspirator

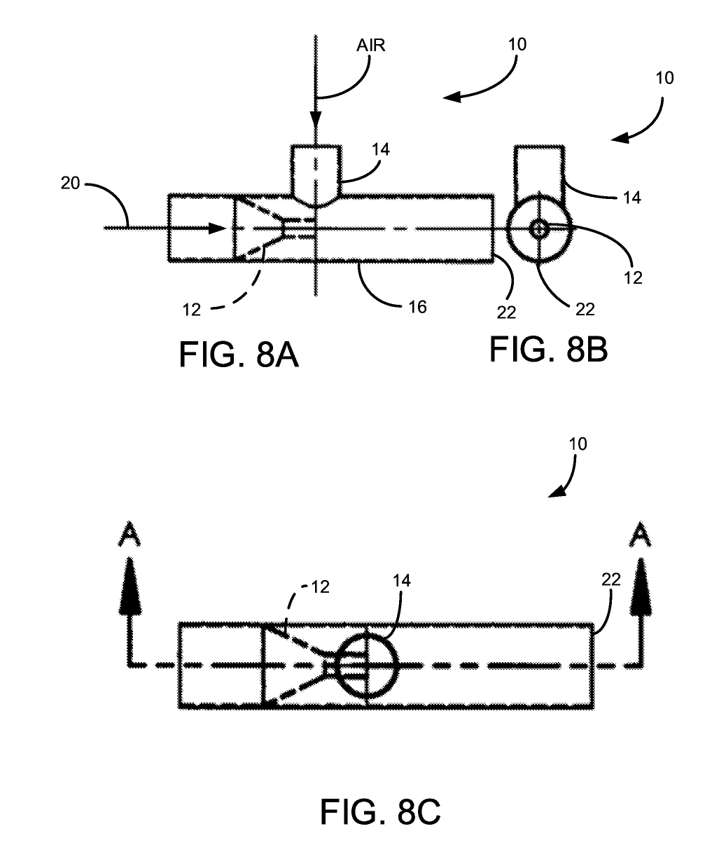

Another implementation of a suitable aspirator 10 for producing fine air bubbles is shown in FIGS. 8A-8E. As shown in FIG. 8A, a stream 20 of water at high pressure mixed with surfactant, e.g., at a concentration of 20 mg/l, entering a funnel-shaped inlet 12 causes air to be drawn into the aspirator 10 via an opening 14 normal to the stream 20. Immediately downstream of the opening 14, in the region 16 (see also FIG. 8D), high shear exists, which promotes mixing of the water and the air, thereby producing fine bubbles. The fine bubbles are then conveyed through an outlet 22 of the aspirator 10 for use as described elsewhere. FIG. 8B shows the aspirator 10 from its downstream end adjacent the outlet 22. FIG. 8C is a top plan view showing the opening 14. FIG. 8D is a section view in elevation showing the funnel shape of the inlet 12. FIG. 8E is a perspective view of the aspirator 10.

### Fine Air Bubble Filter (FABF)

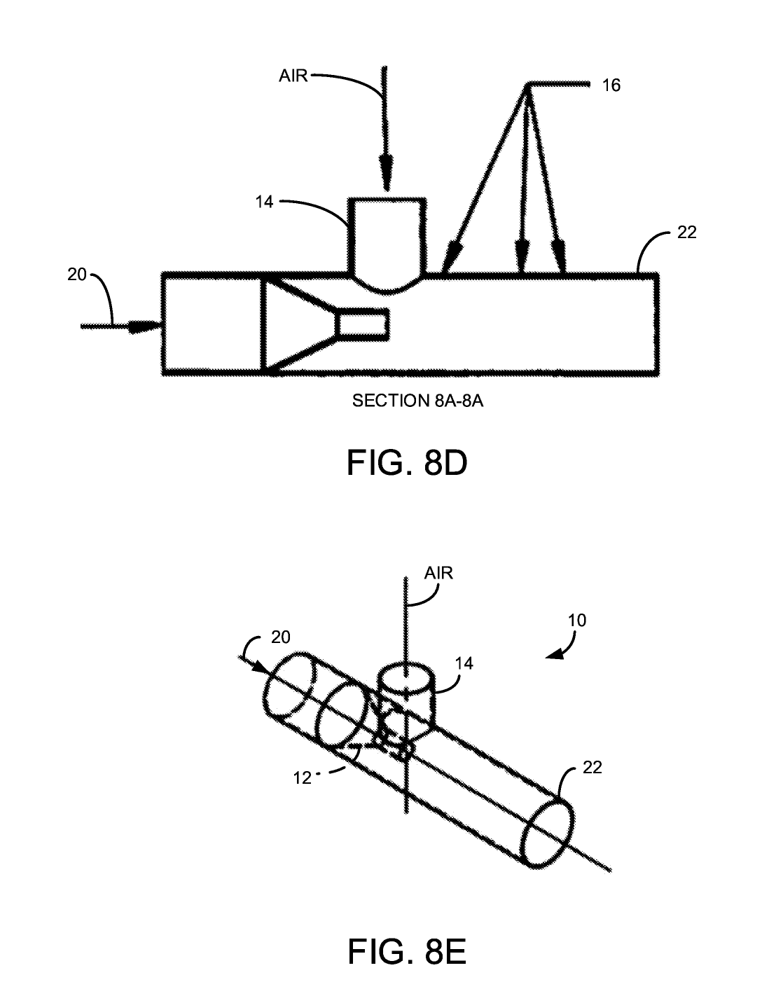

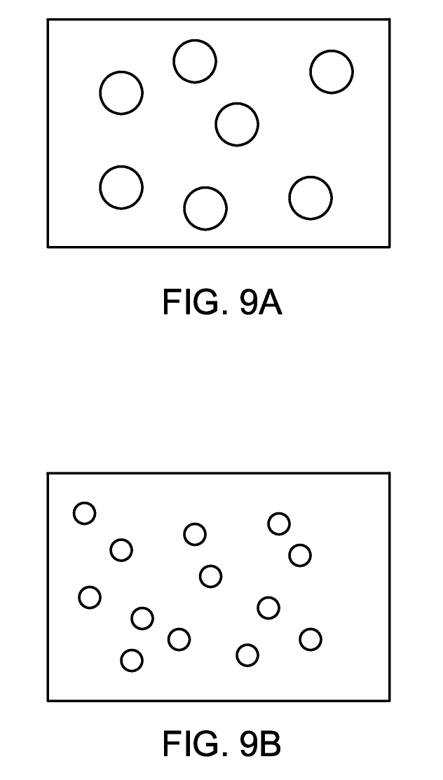

Air bubbles in water have a typical size of about 2 mm (FIG. 9A). The non-coalescing air bubbles created by the aspirator 10 have a size of about 0.5 mm (see FIG. 9B). As a consequence of the smaller air bubbles that do not recoalesce into larger bubbles, the bubble number concentration for an air volume fraction of 20% is 55/cc for normal air bubbles whereas, in the implementations described herein it is almost 1000/cc (FIG. 10). These fine bubbles rise very slowly en masse, creating a filter of air bubbles which, while rising through the wastewater, carries along with it any floating and buoyant neutral materials, “lifting” them vertically until the water surface is reached and the air bubbles are released. As shown in the schematic control volume of FIG. 10, for a unit volume of wastewater having grease and garbage, the fine air bubble filter rises through the wastewater and carries the grease and garbage to the surface (the air rise rate in some implementations is about 2 inches/second) while the wastewater freed of grease and garbage can continue to be processed.

### Pneumatic Sweeping of Grease and Garbage/Recycling

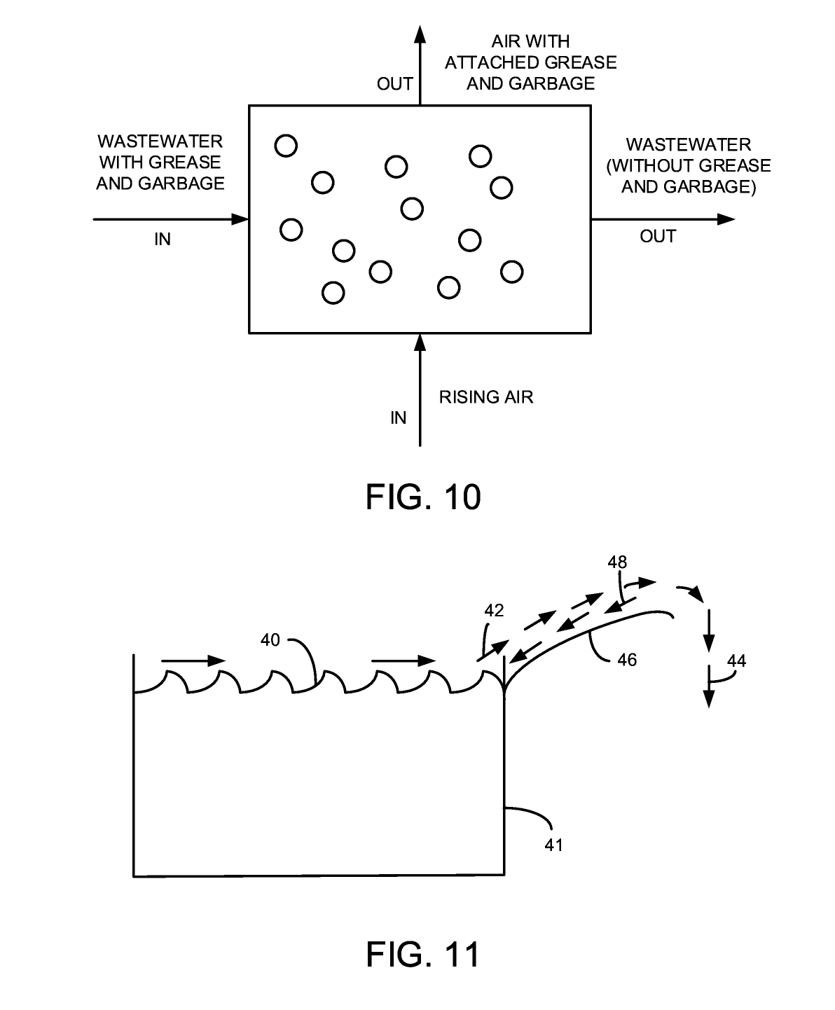

FIG. 11 is a schematic depiction of the grease and garbage material reaching the surface 40 of a tank (or flotation column) 41 under the action of the fine air bubble filter. Once floated, the grease and garbage material, with remaining entrained air bubbles, can be pneumatically swept (arrows 42) by air streams across the surface 40 and up a slightly inclined ramp 46. The grease and garbage, which are now separated (arrow 44) can be collected for disposal. Meanwhile, water in the grease and garbage (arrows 48) drains down the ramp and back into the tank 41.

### Vertically Stacked Flotation Cylinder

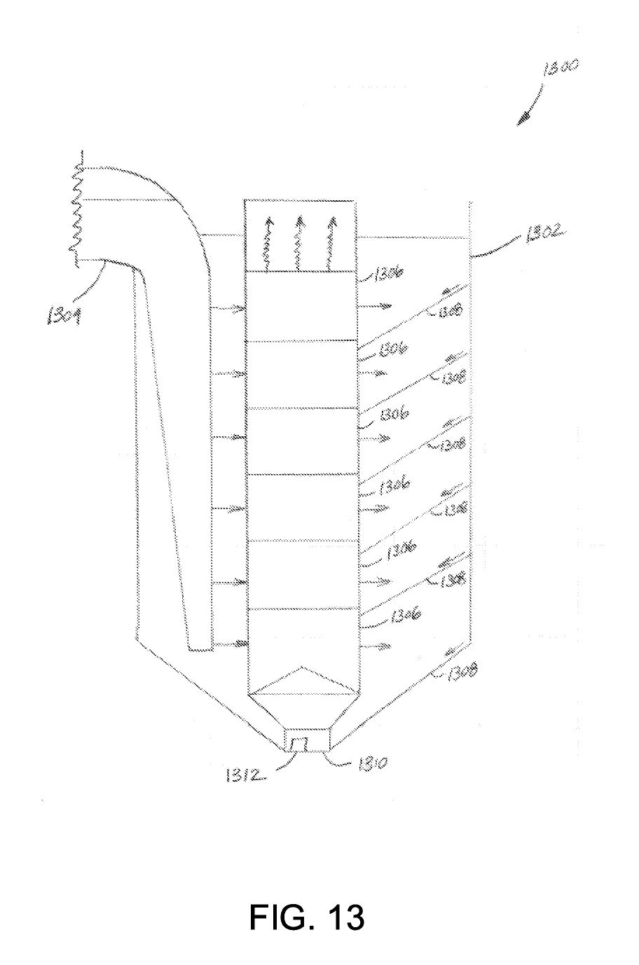

According to another implementation as shown in the sectioned elevation view of FIG. 13, a series of vertically stacked chambers forming a cylinder or column can be aerated to provide for removal of grease and garbage from effluent.

In FIG. 13, a system 1300 includes a tank 1302 in which multiple chambers, such as six chambers 1306, are vertically arranged, e.g., in a cylinder. The tank 1302 receives effluent to be treated that is fed from a duct 1304 at the left side in the figure, which has a series of vertically spaced openings configured to feed each of the multiple chambers 1306. A boundary layer flow is induced around trays 1308 positioned to correspond to the multiple chambers 1306. As the effluent passes through the multiple chambers 1306 as shown by the arrows, grit in the effluent begins to settle, being swept down the sloping trays 1308 towards their central openings by the induced boundary layer flow in an all-hydraulic process. Any gravel in the effluent also settles at the base of the column due to its low specific gravity compared to the aerated water. Grit and gravel are thus collected at the bottom of the tank and are conveyed out of the tank via a hydraulic valve 1310.

Meanwhile, grease and garbage are acted upon by a fine air bubble filter that causes these materials to rise through the column. The fine air bubble filter is established by injecting air and surfactant, such as with the injector 10 from FIG. 8A positioned at 1312 near the base of the tank 1302. Upon reaching the surface, the grease and garbage materials can be skimmed off and removed as described above.

As described, aerated chambers for grease removal are simply tanks which are aerated through diffusers arranged at the base of the chamber with the air rising through the chamber from its base to its top surface. In order to achieve separation of the grease and garbage in a minimal footprint, the floating action is configured to occur in vertically stacked segments. This not only reduces the footprint of separation but also effects a very intimate contact of the wastewater with the FABF.

In order to insure this contact, the flotation chamber segment dimensions must conform to the following conditions:

Let:

$$x 1 = tray outside diameter , ft$$

$$x 2 = tray inside diameter , ft$$

$$A = tray surface area , sf$$

$$A = π / 4 ( x {1}^{2} - x {2}^{2} )$$

$$y = element height , ft$$

$$x = element width and depth , ft$$

$$Uw = horizontal liquid velocity , fps \\ Ua = vertical air bubble velocity , fps$$

$$\begin{matrix}qw = horizontal liquid flow , cfs \\ = x * y * Uw\end{matrix}$$

$$Tw = \frac{x}{Uw} , sec$$

$$Ta = \frac{y}{Ua} , sec$$

For complete contact of air bubbles with the particles in the liquid, set the travel times in the travel times in the element equal,

$$Tw = Ta = T$$

$$or , \\ T = \frac{x}{Uw} = \frac{y}{Ua}$$

For boundary layer 100μ grit settling and classification,

$$qw = ( \frac{12}{450} ) * A , cfs$$

The inside tray diameter, x2, is related to the element horizontal dimension, x, by geometry

x2=\sqrt{2}*x

The non-coalescing shear produced air bubble has a rise velocity of 4/30 fps, or

$$Ua = \frac{4}{30} , fps$$

The horizontal dimension, x, can be related to the liquid flow rate, qw,

$$x = y * ( \frac{Uw}{Ua} ) = y * ( \frac{qw}{x * y} ) * ( \frac{30}{4} )$$

$$or , \\ qw = ( \frac{4}{30} ) * {x}^{2}$$

Example calculation:

Let x1=4,, ft

Then solve the above equations for x and qw to obtain,
x=1.383, ft
qw=0.255, cfs

The vertical dimension, y, is related to the horizontal liquid velocity, Uw,

$$Uw = Ua * \frac{x}{y} = 1.383 * \frac{\frac{4}{30}}{y} = \frac{0.184}{y}$$

For example, for stacked grit removal trays, if y=1 ft, then,
Uw=0.184, fps

It is noted that this is a reasonable result and very close to the sheared non-coalescing air bubble rise velocity, Ua

$$Ua = ( \frac{4}{30} ) = 0.133 , fps$$

An example would be a 1 MGD unit in which the inflow in equally divided into six vertical segments (FIG. 13). The pertinent velocity vectors are shown in FIG. 13. Values can be substituted into the above relationships to obtain segment dimensions. As can be seen, a relatively small flotation chamber diameter is necessary when using the FABF to effect intimate contact between the wastewater and the rising filter.

### Additional Methods Considerations

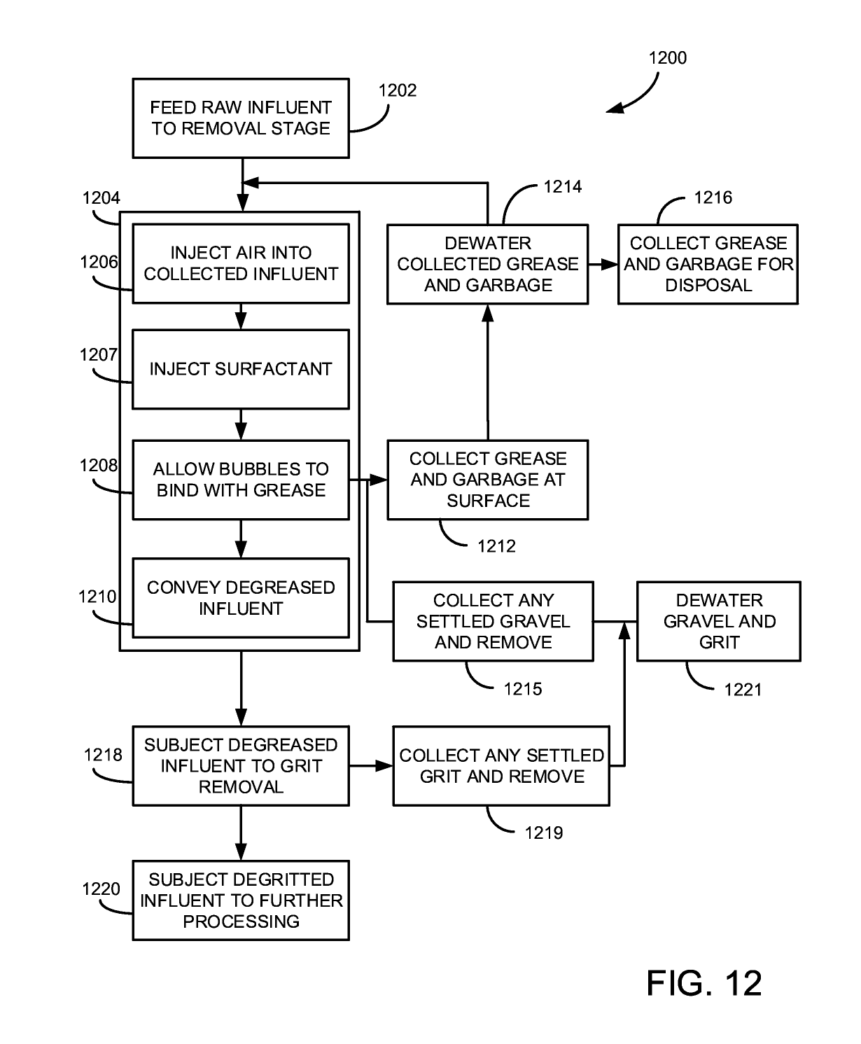

Similar to FIG. 2, FIG. 12 is a flow chart of another nuisance material removal method 1200 according to an alternative implementation.

In step 1202, raw influent is fed into a removal stage. In step 1204, the raw influent is treated to remove grease, and influent in the grease being removed is recycled. At the same time, garbage is removed, and any gravel that has settled is collected.

More specifically, raw influent is collected, such as in a tank, and air and surfactant are injected to create bubbles (step 1206, step 1207). The bubbles tend to bind with the grease in the raw influent as they float to its upper surface (step 1208). At the same time, gravel (and some grit) tends to settle, and garbage tends to float to the surface. The “degreased” influent, which has been subjected to a grease removal process (as well as processes for removing gravel and garbage), can be further processed as required and described elsewhere (step 210).

Meanwhile, grease is collected at the surface (step 1212). In specific implementations, grease is removed from the surface by skimming, such as by using an air stream to move the collected grease (and any garbage that is present) across the surface. It may be advantageous to dewater the collected grease (step 1214) and to then recycle the influent into the grease removal stage. In step 1215, any gravel that has settled is collected for removal, and dewatered as necessary (step 1221).

The grease that has been removed from the surface, as well as any garbage that has surfaced, can be collected (step 1216), such as in a container, for subsequent disposal or recycling.

In step 1218, degreased influent is subjected to an enhanced grit removal stage, which may need to be operated only at a lower capacity because of the grit already removed by settling while the grease was rising. In step 1220, the degreased and degritted influent is subjected to further processing, such as chemical and biological processing stages.

### Additional Considerations

In some implementations, the described system features a single cylindrical tank in which nuisance materials in municipal wastewaters (Grease, Garbage, Gravel, Grit) are separated from the influent wastewater as follows:
1. grease and/or garbage are separated through use of a fine air bubble filter (FABF) operating on a vertically stacked inflow/outflow flotation chamber;
2. pneumatic transport and dewatering of removed grease and garbage;
3. all hydraulic gravel collection and transport via a hydraulic valve; and
4. boundary layer separation and collection of grit on vertically stacked conical trays.

Aspects of boundary layer separation and collection of grit using vertically stacked conical trays are described in U.S. Pat. No. 6,852,239 by the same inventor, which is incorporated herein by reference.

The primary objective in the treatment of municipal wastewaters is the removal of what can be broadly classified as pollutional contaminants, e.g., suspended and settleable solids, contaminants having BOD (biochemical oxygen demand), nutrients (N & P), bacteriological pathogens, toxic contaminants, etc. However, the wastewater entering the treatment plant also has materials that would not be considered as much pollutional as simply a nuisance to deal with.

Nuisance materials may be broadly defined as those materials in the wastewater that are troublesome to deal with and which interfere with the efficient operation of the subsequent treatment processes.
1. Grease generally floats on the surface of treatment units, gumming up mechanisms, and is very difficult to deal with as it attaches itself to every mechanical element it comes in contact with.
2. Garbage is neutrally buoyant, neither settling nor floating. It usually requires some form of screening for its separation.
3. Gravel occurs only occasionally in a raw wastewater, usually during initial storm flow conditions. When it does occur it can destroy fine screens and it interferes with sludge handling.
4. Grit is inorganic material smaller than ⅛″. It accumulates in processes in which it cannot be maintained in suspension (e.g., aeration basins, anaerobic digesters) requiring taking processes out of operation for its removal.

Aerated chambers are sometimes employed for grease removal. The efficiency of removal is low due to turbulent mixing induced by the use of coarse air bubbles. Also, the mechanical elements used in the collection of the separated grease accumulate the grease, requiring regular maintenance for cleaning.

Fine screening is employed for garbage removal. It can be effective, however, it is costly equipment and it is vulnerable to damage by gravel inflows under peak flow events.

There is no process that is designed specifically for gravel removal. As an intermittent occurrence, its effects are generally dealt with after the event. In plants having frequent peak wet weather events, gravel can cause the shutdown of entire trains of the wastewater treatment processes.

Until the inventor's discovery, grit was assumed to behave like clean sand of the same size. In fact, due to the attached grease, the grit particle settles at a much lower velocity than a sand particle of the same size; i.e., it settles like a smaller sand particle. The Sand Equivalent Size (SES) of grit is the design criterion used in the effective design of grit removal systems. In general, a grit system designed for the removal of 100 micron SES will remove most of this material ahead of the subsequent treatment processes.

The best location for an implementation of the disclosed systems and methods is prior to any treatment process, i.e., at the headworks. Since the disclosed systems accomplish separation of all of the nuisance materials as described above in a single unit, the footprint of the process lends itself to being a headworks process.

In view of the many possible embodiments to which the disclosed principles may be applied, it should be recognized that the illustrated embodiments are only preferred examples and should not be taken as limiting in scope. Rather, the scope of protection is defined by the following claims. We therefore claim all that comes within the scope and spirit of these claims.

We claim:

1. A method of treating wastewater, comprising:
introducing air bubbles having a predetermined size into raw influent;
allowing the air bubbles time to bind with grease particles in the influent and to rise; and
collecting the grease particles bound with air bubbles on an open upper surface of the influent.

2. The method of claim 1, further comprising collecting garbage that has floated to the top of the open upper surface.

3. The method of claim 1, further comprising conveying degreased influent to a grit removal stage.

4. The method of claim 1, wherein introducing air bubbles having a predetermined size into the raw influent includes using an injector with a water-surfactant motive flow to entrain air and injecting the resulting water-surfactant-air mixture into the raw influent.

5. The method of claim 1, wherein introducing air bubbles includes injecting air bubbles with an array of injectors.

6. The method of claim 1, further comprising causing gravel in the influent to settle as the air bubbles are rising.

7. The method of claim 1, wherein collecting the grease particles bound with the bubbles includes skimming an upper surface of the influent to remove the grease.

8. The method of claim 1, wherein collecting the grease particles bound with bubbles includes skimming an upper surface of the influent with an air stream to remove the grease.

9. The method of claim 8, further comprising dewatering the removed grease and adding liquid removed from the grease to the raw influent for recycling.

10. The method of claim 1, further comprising urging at least removed grease up a ramp positioned adjacent the upper surface of the influent and concurrently dewatering the removed grease.

11. A removal stage configured to remove at least one nuisance material from wastewater, comprising:
a tank sized to receive an inflow of influent;
at least one injector positioned at a bottom of the tank to inject a mixture of liquid and air in the form of air bubbles having a predetermined size into influent received in the tank, the air bubbles being configured to bind with at least grease particles in the influent and rise through the tank;
a skimming device positioned to skim the grease particles bound with air bubbles from a top surface of the tank.

12. The removal stage of claim 11, wherein the at least one injector comprises an array of at least eight injectors arranged about a central axis of the tank.

13. The removal stage of claim 11, wherein the skimming device comprises a nozzle positioned to direct an air stream onto the top surface of the tank and to move accumulated grease to an opposite side.

14. The removal stage of claim 11, further comprising a supply of surfactant for providing surfactant in the mixture of liquid and air, the surfactant tending to keep the predetermined size of the bubbles small.

15. The grease removal stage of claim 11, wherein in operation there is a filter of dispersed air bubbles rising through the influent that produces a local region of lower density permitting faster settling of gravel in the influent.

16. The removal stage of claim 11, further comprising at least one outlet and a grit removal stage connected to the outlet.

17. The removal stage of claim 16, wherein the removal stage and the grit removal stage are positioned together in the tank.

18. The removal stage of claim 16, wherein the outlet comprises multiple, vertically spaced outlets sized and shaped to have equal flow and to connect to a hydraulic grit separation stage.

19. The removal stage of claim 16, further comprising a gravel collection region at the bottom of the tank for storing gravel that has settled from the influent.

20. The removal stage of claim 16, wherein the skimming device is configured to collect garbage from the influent that floated to the surface of the tank.
